(19) United States
(12) Patent Application Publication
(10) Pub. No.: US 2006/0034071 A1
(43) Pub. Date: Feb. 16, 2006

(54) Light-emitting diode lamp

(75) Inventors: Bily Wang, Hsin Chu City (TW); Jonnie Chuang, Taipei Hsien (TW); Ching-Hung Ko, Tai Nan City (TW); Chun-Cheng Weng, Yuan Hsien (TW)

Correspondence Address: TROXELL LAW OFFICE PLLC;SUITE 1404, 5205 LEESBURG PIKE, FALLS CHURCH, VA, 22041, US

(73) Assignee: Harvatek Corporation

(21) Appl. No.: 10/915,537

(22) Filed: Aug. 11, 2004

(51) Int. Cl. F21L 4/00

(52) U.S. Cl. 362/157

(57) ABSTRACT

An LED lamp is enabled to evenly emit lights, and is provided with a single set of indicators to provide different colors of light, and as least comprises a tubular case, a circuit board and at least an LED. The inner wall of the tubular case has a rough, light-homogenizing layer disposed thereon. The circuit board is provided together with a control unit on the bottom of the tubular case. The color mixing LED is provided on the circuit board.

### FIELD OF THE INVENTION

This invention refers to a light-emitting diode lamp, and more particularly to a lamp with a light-emitting diode as its light source, enabling emission of different colors of light to indicate different states for highlighting purposes, or for decoration.

### DESCRIPTION OF THE PRIOR ART

In some noisy situations where an audible alarm is difficult to hear, a warning light is used as an alarm; for example, during operation of machines, alarm or mechanical indication is provided by lights that emit different colors of light to indicate different states. For example, a red light indicates risk or stop, a green light indicates continuing operation, a yellow light indicates paying attention, and so on.

Referring to FIG. 1, a common light-emitting diode (LED) lamp currently available on the market is shown, which is used with a machine. The LED lamp 9 comprises three layers of transparent cases 91, 92 and 93 with different colors. Each is provided with a white light source, typically where either an electrical bulb or an LED is used as the light source.

As shown in the figure, in the prior art, a respective circuit board 94, 95 and 96 is provided respectively inside the corresponding case 91, 92 and 93, and multiple LEDs 942, 952 and 962 are provided on each of the circuit boards. The LED lamp 9 further comprises a basement and a lever 97 arranged to be kept upright.

The above-mentioned LED lamp 9 is provided with a longitudinally corrugated convex pole 912, so that the light emitted from the cases is evenly received from different view angles. Some light rays, however, are still locally stronger or weaker, and, further, external light is easily transmitted inward due to the transparent material, resulting in the influence on the emittance of the outgoing light.

Furthermore, the operator needs to pay extra attention to which case is illuminated by viewing from both the top and the lower positions. If the external light is strong, it is likely that the light emitted from the LED lamp 9 is not differentiated, thus resulting in a reduced alarm effect, and indirectly causing delays or mistakes.

Additionally, in the above-mentioned LED lamp 9, one set of indicators is required for each color of light. If more colors of light are necessary, this results in the increased total used space and increased cost.

Accordingly, there is a need to resolve the above inconveniences and disadvantages of the conventional LED lamp in the actual application.

### SUMMARY OF THE INVENTION

It is a main object of this invention to provide an LED lamp, enabling even emission of light and preventing influence from strong external light.

It is another object of this invention to provide an LED lamp with one single set of indicators to provide different colors of light, thus reducing the cost and used space, as well as allowing the operator to pay less attention to operation.

In order to achieve the main objects mentioned above, the LED lamp according to this invention comprises a tubular case on whose inner wall is disposed a rough, light-homogenizing layer, a circuit board provided together with a control unit on the bottom of the tubular case, and at least an LED provided on the circuit board.

In order to achieve the another object mentioned above, the LED lamp according to this invention uses an LED, which is a color mixing LED.

In the following, the invention will be described in greater detail in connection with preferred embodiments and with reference to the accompanying drawings, but the description is merely for illustrative purpose, without any limitation to the scope of the present.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a block diagram of an LED lamp according to the prior art;

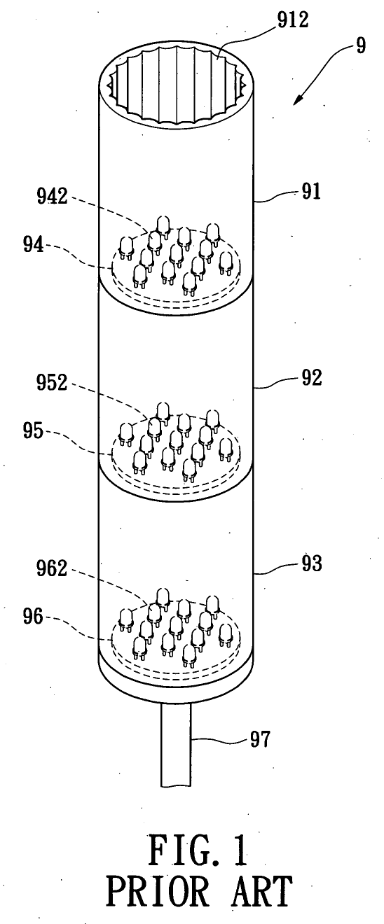

FIG. 2 is a block diagram of an LED lamp according to the present invention; and

FIG. 3 is a cross-section diagram of an LED lamp according to the present invention.

### DESCRIPTION OF THE PREFERRED EMBODIMENTS

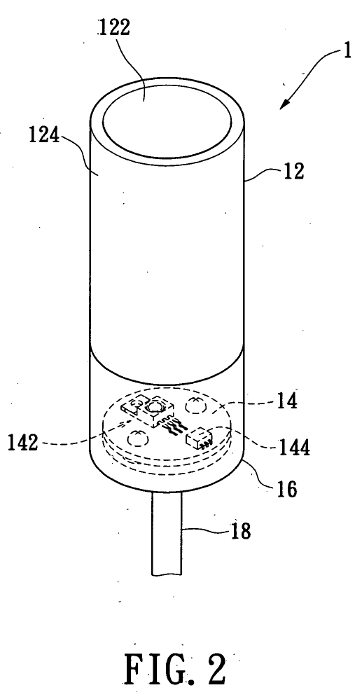

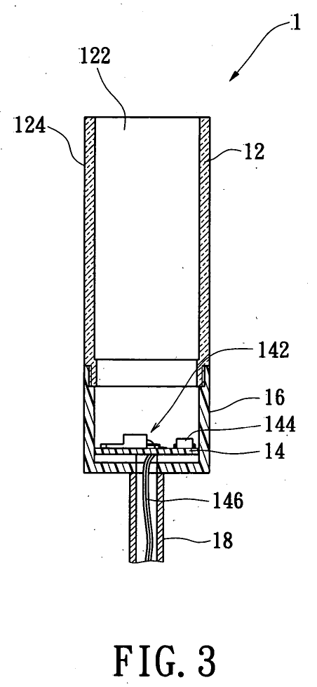

Referring to FIG. 2, a assembly diagram of an LED lamp according to the present invention is shown. The LED lamp according to this invention comprises a tubular case 12, a circuit board 14 and at least an LED 142. The tubular case 12 is made of a colorless transparent material, through which the light of the LED 142 can be transmitted. Preferably, the material is plastic, but may be other materials as well. The inner wall of the tubular case 12 is formed with a rough, light-homogenizing layer 122, which is made by a coarsening treatment to form a rough micro-layer, so as to reflect the light rays back and forth by the surface of the inner wall 122 of the tubular case 12 to conduct diffused lights to exit, as shown in FIG. 3.

In particular, the outer layer 124 of the tubular case 12 may be made of a plastic material with low transmission, or may be undergo a coarsening treatment to form a coarsened surface, so as to reduce transmission of external light the tubular case to alleviate the influence of the external light.

The circuit board 14 may be a rigid printed circuit board or flexible printed circuit board, which is disposed on the bottom of the tubular case 12. A control unit 144 is provided to control the LED 142 disposed on the circuit board 14. The LEDs 142 are at least one in number. In this embodiment, one color mixing LED is provided, which is characterized by multiple colors of chips controlled by the control unit 144 to emit different colors of light.

In this way, the LED lamp 1 according to the invention can evenly emit different colors of light by means of the outer layer design of the tubular case 12, thus avoiding the influence from strong external light. Furthermore, the LED lamp 1 according to this invention uses a color mixing LED, so as to only use a single set of LED indicators to provide different colors of light, thus reducing the cost and used space. Further, the operator does not need to pay extra attention to which one is illuminated.

The above-mentioned tubular case 12 may be directly formed on a machine, or a further connector portion 16 may be provided to connect to the tubular case 12, and a lever 18 is connected to the bottom of the connector portion 16, thus enabling the LED lamp 1 to be upright. In this case, the circuit board 14 is provided inside the connector portion 16, for example, to be fixed in screw-locked or rivet-connected manner to the bottom of the connector portion 16. The connector portion 16 can be spirally connected with tubular case 12 in spiral-connected manner. Of course, other connecting methods, such as hooking or bonding may be used. The connector portion 16 and the lever 18 may be formed as a whole body, or the lever 18 may be screw-locked and fixed to the connector portion 16 or fitted or bonded with the connector portion 16. Conductive wires 146 may be arranged through the interior of the lever 18.

In the LED lamp 1 according to the invention, the tubular case 12 may be formed with an upward opening in its top, or may be formed so as to be closed, in order to prevent any foreign matter from entering.

In the LED lamp 1 according to the invention, the tubular case 12 may be modified in shape, for example, to be of curved or stream shape, such that it can be used as lamps and lanterns for decoration purpose. For example, the LED lamp can be hong from the ceiling to emit different colors of light, for advertisement or decoration. The control unit 144 can be provided with the function of timing control, so as to enable a same LED to change its color over time.

Therefore, the following features and advantages can be obtained by this invention:

The LED lamp according to the invention can evenly emit light by means of the design of its tubular case, thus avoiding influence from strong external light.

The LED lamp according to this invention enables one single set of indicators to provide different colors of light, thus reducing the cost and used space, as well as allowing the operator to pay less attention to operation.

In conclusion, this invention fully meets the requirements for the patent application. Therefore, The application is proposed according to the patent law. While the preferred embodiments of this invention have disclosed above, they are not indented to limit the scope of this invention. Therefore the appended claims cover all such changes or modifications as fall within the spirit and scope of this present invention.

What is claimed is:

1. An LED lamp, comprising:
a tubular case, an inner wall thereof having a rough, light-homogenizing layer disposed thereon;
a circuit board provided together with a control unit on a bottom of the tubular case; and
at least one LED provided on the circuit board.

2. The LED lamp according to claim 1, further comprising a connector portion connected with the tubular case and a lever connected with a bottom of the connector portion.

3. The LED lamp according to claim 2, wherein the circuit board is provided inside the connector portion.

4. The LED lamp according to claim 2, wherein the connector portion is screwed or embedded with the tubular case.

5. The LED lamp according to claim 1, wherein the tubular case is made of a colorless transparent material.

6. The LED lamp according to claim 1, wherein an outer layer of the tubular case is made of a plastic material with low transmission.

7. The LED lamp according to claim 1, wherein an outer layer of the tubular case is formed with a coarsened surface.

8. The LED lamp according to claim 1, wherein the tubular case is formed with an upward opening.

9. The LED lamp according to claim 1, wherein a top of the tubular case is closed.

10. The LED lamp according to claim 1, wherein the LED is a color mixing LED.
